(19) United States
(12) Patent Application Publication
(10) Pub. No.: US 2026/0022308 A1
(43) Pub. Date: Jan. 22, 2026

(54) INKJET HEAD CLEANING SOLUTION

(71) Applicant: KYOCERA DOCUMENT SOLUTIONS INC., OSAKA (JP)

(72) Inventor: MASAFUMI SAITO, OSAKA (JP)

(21) Appl. No.: 19/273,041

(22) Filed: Jul. 17, 2025

(30) Foreign Application Priority Data
Jul. 19, 2024 (JP) 2024-115696

(51) Int. Cl. C11D 1/00; C11D 3/37; C11D 3/382

(52) U.S. Cl. CPC C11D 1/008; C11D 3/3765; C11D 3/382

(57) ABSTRACT

An inkjet head cleaning solution that is used for cleaning an inkjet head with a blade. The inkjet head cleaning solution includes a silicone surfactant and a polycarboxylic acid polymer salt. In addition, the inkjet head cleaning solution has a pH value of 7 or more and 8 or less.

### CROSS-REFERENCE TO RELATED PATENT APPLICATION

This application claims the benefit of Japanese Priority Patent Application JP 2024-115696 filed Jul. 19, 2024, the entire contents of which are incorporated herein by reference.

### FIELD OF THE DISCLOSURE

The present disclosure relates to an inkjet head cleaning solution.

### BACKGROUND OF THE DISCLOSURE

In inkjet recording apparatuses, the mist of ink adheres to the nozzle surface of the inkjet head during a recording operation, dries, and solidifies, causing the solidified ink to be accumulated on the nozzle surface. Such solidified ink grows and blocks the ink ejection port, causing ejection abnormalities such as misdirection and non-ejection.

In recent years, inks that strongly adhere to the nozzle surface, such as water-based inks with improved wettability and a low environmental impact have begun to be used for non-absorbent media such as coated paper and a film. For this reason, the solidified ink is chemically removed with a cleaning solution, as well as the solidified ink is physically removed by a cleaning operation such as ink purging and nozzle wiping.

For example, Japanese Patent Application Laid-open No. 2000-127419 discloses a technology for removing the solidified ink by purging a mixture of a cleaning solution obtained by combining a surfactant and a basic compound and an ink from a nozzle. Further, Japanese Patent Application Laid-open No. 2016-112763 discloses a technology for removing the solidified ink by wiping the nozzle surface with a wiping member such as a cloth impregnated with a silicone surfactant.

### SUMMARY OF THE DISCLOSURE

An inkjet head cleaning solution according to an embodiment of the present disclosure is used for cleaning an inkjet head with a blade.

The inkjet head cleaning solution includes: a silicone surfactant; and a polycarboxylic acid polymer salt.

The inkjet head cleaning solution has a pH of 7 or more and 8 or less.

### BRIEF DESCRIPTION OF THE DRAWINGS

FIG. 1 is a diagram describing a method of cleaning an inkjet head with a blade wipe method using a cleaning solution according to an embodiment of the present disclosure.

FIG. 2 is a graph showing the (estimated) residual amount of a silicone surfactant in cleaning solutions with different pH values as a function of preservation months at a preservation temperature of 40° C.

### DETAILED DESCRIPTION OF THE EXEMPLARY EMBODIMENTS

An embodiment of the present disclosure will be described below.

### Overview of Present Disclosure

### (Overall Configuration)

An inkjet head cleaning solution according to an embodiment of the present disclosure (hereinafter, referred to simply also as a “cleaning solution”) is used for cleaning an inkjet head with a blade. The cleaning solution according to this embodiment includes a silicone surfactant and a polycarboxylic acid polymer salt, and has pH of 7 or more and 8 or less.

In the cleaning solution according to this embodiment, the pH is adjusted to be neutral, i.e., 7 or more and 8 or less. In the cleaning solution according to this embodiment, both the effect of the silicone surfactant and the effect of the polycarboxylic acid polymer salt are effectively exerted under the neutral conditions, thereby maintaining the high cleaning performance. The effect of the silicone surfactant and the effect of the polycarboxylic acid polymer salt will be described.

The silicone surfactant is a surfactant having a siloxane bond (—Si—O—Si—). The silicone surfactant used in this embodiment acts as a surface tension modifier that reduces the static surface tension of the cleaning solution. This allows the cleaning solution to wet and spread uniformly on the nozzle surface even if a non-absorbent blade is used. As a result, the cleaning solution is brought into close contact with and easily penetrates the solidified ink, making the solidified ink on the nozzle surface easier to peel off.

Further, the silicone surfactant is a surfactant having a structure in which a hydrophilic substituent group is introduced into part of the silicone having a hydrophobic siloxane bond as the main skeleton, and therefore exhibits its own cleaning effect.

The silicone surfactant tends to undergo hydrolysis due to water or heat as it is further away from neutrality. In the cleaning solution according to this embodiment, the hydrolysis of the silicone surfactant is inhibited because it is under neutral conditions. As a result, in the cleaning solution according to this embodiment, since the content of the silicone surfactant changes little over time, the performance is maintained for one year or more, which is the minimum required preservation period, thereby achieving excellent preservation stability.

In addition, the silicone surfactant is hard to decompose in the environment unlike fluorine surfactants expected to reduce surface tension similarly, and therefore has no environmental accumulation issues and offers environmental advantages.

Further, the polycarboxylic acid polymer salt is a water-soluble polymer including a salt of a polyvalent carboxy group (in neutralized form). The polycarboxylic acid polymer salt acts as a cleaning agent for removing the solidified ink even under neutral conditions. That is, the polycarboxylic acid polymer salt is capable of sufficiently exerting the cleaning effect even under neutral conditions where basic compounds commonly used as cleaning agents cannot exert their cleaning effects sufficiently. The present inventors believe that this is because the salt of a polyvalent carboxy group exerted the effect of improving the compatibility between the cleaning solution and the component in the solidified ink (particularly, a dispersant component), thereby enhancing the removability of the solidified ink even under neutral conditions.

Further, in the cleaning solution according to this embodiment, the polycarboxylic acid polymer salt also acts as a cleaning aid (builder agent) that enhances the cleaning effect of the silicone surfactant, thereby achieving a higher cleaning effect.

As described above, in the cleaning solution according to this embodiment, both the cleaning effect of the polycarboxylic acid polymer salt and the effect of enhancing wettability by the silicone surfactant are exerted under neutral conditions, and a high cleaning effect capable of sufficiently removing the solidified ink even with a blade wipe method is achieved as a synergistic effect of these. Further, in the cleaning solution according to this embodiment, since it is under neutral conditions, the hydrolysis of the silicone surfactant is inhibited and a high cleaning effect is maintained for a long period of time.

The cleaning method of wiping the nozzle surface with a wiping member such as a cloth, which is described in the above “Background”, is referred to as a “cloth wipe method”. Meanwhile, the cleaning method of wiping the nozzle surface with a blade is referred to as a “blade wipe method”. In the blade wipe method, since the cleaning solution does not soak into the wiping member unlike the cloth wipe method, the cleaning solution is difficult to come into contact with the nozzle surface uniformly, and thus, the cleaning effect of the cleaning solution is not often sufficiently achieved. On the other hand, according to the inkjet head cleaning solution according to an embodiment of the present disclosure, a high cleaning effect can be achieved even with the blade wipe method.

### (Cleaning Method)

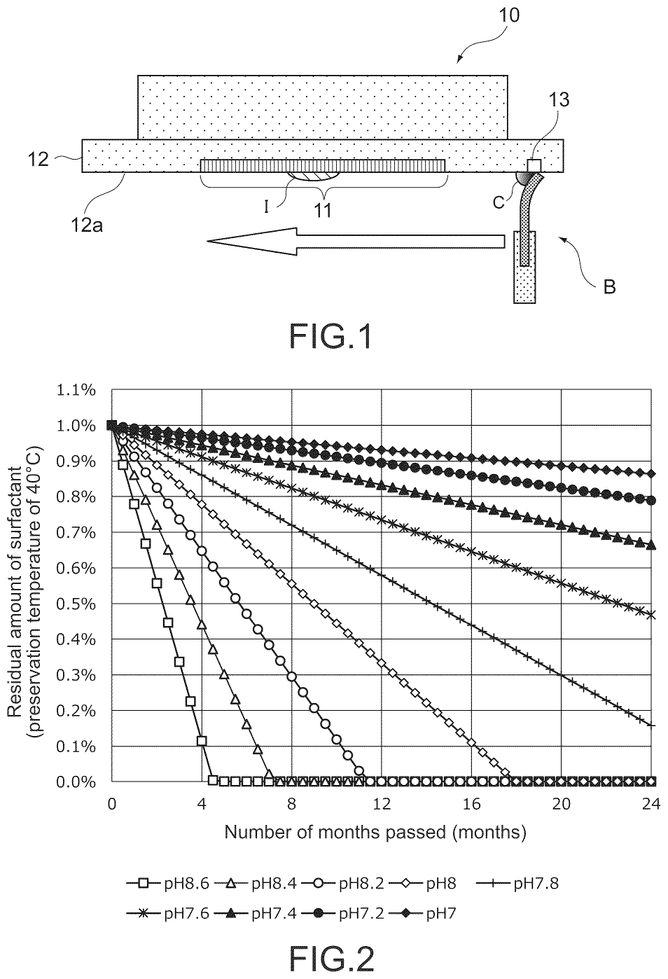

FIG. 1 is a diagram describing a method of cleaning an inkjet head with a blade wipe method using the cleaning solution according to this embodiment. As shown in FIG. 1, a nozzle plate 12 is provided at the bottom portion of an inkjet head 10. A plurality of ink ejection ports 11 is arranged on the lower surface (nozzle surface 12a) of the nozzle plate 12. During the recording operation, the ink adhered to the nozzle surface 12a dries and forms a solidified ink I. In order to remove the solidified ink I, a wipe operation of sliding a blade B formed of rubber along the nozzle surface 12a (in the direction indicated by the left arrow in FIG. 1) is performed.

Immediately before this wipe operation, a cleaning solution C is supplied from a cleaning solution supply port 13 to the nozzle surface 12a. The cleaning solution C having low surface tension quickly wets and spreads along the nozzle surface 12a, covering the entire surface of the nozzle surface 12a without any gap. As a result, the cleaning solution C is brought into close contact with and penetrates the entire solidified ink I on the nozzle surface 12a, and thus, the cleaning effect of the silicone surfactant and the polycarboxylic acid polymer salt in the cleaning solution C is effectively exerted on the solidified ink I, thereby making the solidified ink I easier to peel off. The solidified ink I on the nozzle surface 12a is scraped off by the tip portion of the blade B during the sliding of the blade B, and is easily removed by moving together with the blade B. The wipe operation is favorably performed two or more times in the case where the amount of the solidified ink I on the nozzle surface 12a is large.

In the blade wipe cleaning method, a blade formed of a soft material such as rubber is used. For this reason, the blade wipe cleaning method is less likely to cause damage to the nozzle surface 12a than the cloth wipe cleaning method using a wiping member formed of a hard material such as pulp. Therefore, in this embodiment, the function of ejecting the ink normally in the inkjet head is maintained for a long period of time.

As described above, according to the cleaning solution according to this embodiment, high removability similar to that of the cloth wipe method can be obtained even with the blade wipe method, while achieving the advantage of extending the lifetime of the inkjet head with the blade wipe method.

### DETAILED CONFIGURATION OF PRESENT DISCLOSURE

### (Cleaning Solution)

The pH of the cleaning solution according to this embodiment is adjusted to 7 or more and 8 or less from the viewpoint of inhibiting the hydrolysis of the silicone surfactant. More favorably, the pH of the cleaning solution is 7 or more and 7.2 or less. This allows the hydrolysis of the silicone surfactant to be inhibited even at a relatively high preservation temperature of 40° C. where the hydrolysis is likely to occur, and high cleaning performance is maintained even after one year or more.

The static surface tension of the cleaning solution according to this embodiment at 25° C. is favorably 29 mN/m or less, more favorably 25 mN/m or less, and still more favorably 22 mN/m or less, from the viewpoint of uniformly spreading the cleaning solution on the nozzle surface.

The viscosity of the cleaning solution according to this embodiment is not particularly limited, but is favorably, for example, in the range close to that of a general ink, favorably 3 mPa·s or more and 12 mPa·s or less, and more favorably 6 mPa·s or more and 8 mPa·s or less. As a result, even if the cleaning solution mixes with the ink after cleaning, the viscosity of the ink does not change significantly, thereby maintaining the stable ejection property.

The pH, static surface tension, and viscosity of the cleaning solution are affected by the components constituting the cleaning solution and the composition ratios thereof. However, as necessary, the pH is adjusted by the content of a pH adjuster, the static surface tension is adjusted by the content of a surface tension modifier, and the viscosity is adjusted b the content of a viscosity adjustor.

The components constituting the cleaning solution according to this embodiment will be described below.

### (Silicone Surfactant)

The silicone surfactant used in the cleaning solution according to this embodiment is not particularly limited, but is favorably a polyether-modified silicone, more favorably a polyether-modified polydimethylsiloxane.

In particular, as the polyether-modified polydimethylsiloxane, a polyether-modified silicone in which ethyleneoxide and/or propyleneoxide are introduced as polyether groups into a side chain or the terminal of the silicone chain of polydimethylsiloxane is favorable. For example, it has more favorably a repeating unit represented by the following general formula (1), still more favorably the repeating unit represented by the following general formula (1) and a terminal group represented by the following general formula (2).

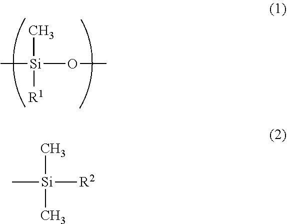

R¹ in the formula (1) and R² in the formula (2) each independently represent a methyl group or a polyether group. However, at least one of R¹ or R² represent a polyether group. The polyether group is a group including one or both of —C₂H₄O— and —C₃H₆O—.

As the silicone surfactant, one type of silicone surfactant may be used alone, or two or more types of silicone surfactants may be mixed and used.

The content of the silicone surfactant in the cleaning solution according to this embodiment is not particularly limited as long as a sufficient cleaning effect is exerted, but is favorably 0.02 mass % or more and 1 mass % or less, more favorably 0.06 mass % or more and 1 mass % or less, and still more favorably 0.09 mass % or more and 1 mass % or less. By setting the content of the silicone surfactant to 1 mass % or less, the formation of insoluble matters is suppressed and the silicone surfactant is less likely to separate in the cleaning solution. As a result, the silicone surfactant is dispersed more uniformly, and it is possible to improve wettability uniformly. By setting the content of the silicone surfactant to 0.02 mass % or more, it is possible to improve the wettability. From the viewpoint of further enhancing the removability of the solidified ink, the content of the silicone surfactant is set to more favorably 0.06 mass % or more, still more favorably 0.09 mass % or more. Note that as the content of the silicone surfactant increases, the static surface tension decreases, but the static surface tension remains nearly constant when the content of the silicone surfactant is 0.09 mass % or more.

### (Polycarboxylic Acid Polymer Salt)

The salt of a carboxy group in a polycarboxylic acid polymer salt according to this embodiment is represented by a-COOM group. M favorably represents a metal atom. The metal atom forming M can be selected from alkali metal atoms such as sodium and potassium, alkaline earth metal atoms such as calcium, transition metal atoms such as iron, and the like, and is favorably an alkali metal atom, more favorably a sodium atom.

The polycarboxylic acid polymer salt according to this embodiment is not particularly limited, but may be, for example, a homopolymer of an ethylenically unsaturated monocarboxylic acid salt monomer such as an acrylic acid salt, a methacrylic acid salt, and a crotonic acid salt, a homopolymer of an ethylenically unsaturated dicarboxylic acid salt monomer such as a maleic acid salt, a fumaric acid salt, and an itaconic acid salt, or a copolymer including one or more ethylenically unsaturated monocarboxylic acid salt monomers and/or one or more ethylenically unsaturated dicarboxylic acid salt monomers.

The polycarboxylic acid polymer salt according to this embodiment may be a copolymer including a different monomer other than the ethylenically unsaturated monocarboxylic acid salt monomer and the ethylenically unsaturated dicarboxylic acid salt monomer described above. As the different monomer, for example, an ethylenically unsaturated monomer having an anionic group other than the COOM group may be included, and an ethylenically unsaturated monomer having a sulfonate (SO₃M) group as an anionic group is more favorably included. The anionic group may be directly bonded to the ethylene chain (via a single bond) or indirectly bonded to the ethylene chain via a spacer. In addition, the polycarboxylic acid polymer salt may have, in the main chain or a side chain, an ether structure such as —[CH₂—CH₂—O]— other than the ethylenically unsaturated monocarboxylic acid salt monomer and the ethylenically unsaturated dicarboxylic acid salt monomer.

The polycarboxylic acid polymer salt according to this embodiment is favorably one or more of a polyacrylic acid salt having a repeating unit represented by the following general formula (3), a polyacrylic acid/maleic acid copolymer salt having the repeating unit represented by the following general formula (3) and a repeating unit represented by the following general formula (4), or an acrylic acid/sulfonic acid monomer copolymer salt having the repeating unit represented by the following general formula (3) and a repeating unit represented by the following general formula (5) (sulfonate group-containing ethylenically unsaturated monomer).

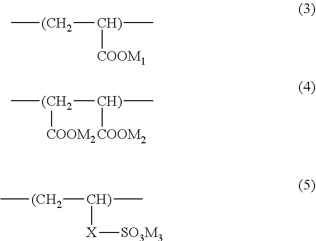

In the general formulae (3) to (5), M₁ to M₃ each represent a metal atom and may be the same or different from each other. X represents a single bond or a spacer, and is not particularly limited as long as the effect of the present invention is not impaired.

In particular, the polycarboxylic acid polymer salt according to this embodiment is more favorably a sodium acrylate polymer or a sodium polyacrylic acid/maleic acid copolymer where M₁ in the general formula (3) and M₂ in the formula (4) each represent sodium from the viewpoint of ease of availability, still more favorably a sodium maleic acid/acrylic acid copolymer including a maleic acid salt monomer with a large number of COOM groups from the viewpoint of the compatibility with the components in the solidified ink (particularly, dispersant component).

The polycarboxylic acid polymer salt according to this embodiment favorably has a high molecular weight, and the weight average molecular weight (Mw) thereof is favorably 1,000 or more and 1,000,000 or less, more favorably 2,000 or more and 5,000 or less.

The content of the polycarboxylic acid polymer salt is favorably 0.01 mass % or more and 5 mass % or less. By setting the content of the polycarboxylic acid polymer salt to 0.01 mass % or more, high cleaning performance is easily achieved. Further, by setting the content of the polycarboxylic acid polymer salt to 5 mass % or less, a favorable ink ejection property is easily achieved. That is, when the content of the polycarboxylic acid polymer salt exceeds 5 mass %, the polycarboxylic acid polymer salt remains on the nozzle surface after cleaning, dries, and blocks the ink ejection port, thereby making an ink ejection failure more likely to occur.

As the polycarboxylic acid polymer salt, one type of polycarboxylic acid polymer salt may be used alone, or two or more of them may be used in combination.

### (Other Components)

The cleaning solution according to this embodiment may include, as the remainder of the above-components, water, a pH adjuster, or a viscosity adjustor. Further, as necessary, the cleaning solution may further include known additives (more specifically, a dissolution stabilizer, an anti-drying agent, an antioxidant, and an antifungal agent).

### Water

Water has a function as a solvent for dissolving the above-mentioned polycarboxylic acid polymer salt, silicone surfactant, and pH adjuster. Examples of the water included in the cleaning solution include purified water and ion exchanged water.

The content of water in the cleaning solution according to this embodiment is favorably 30 mass % or more and 80 mass % or less from the viewpoint of the compatibility with water-based ink.

### pH Adjuster

The pH adjuster is not particularly limited as long as the pH of the cleaning solution can be adjusted to 7 or more and 8 or less. The pH adjuster may be either an acidic compound or a basic compound. The pH of the cleaning solution according to this embodiment tends to be alkaline because the polycarboxylic acid polymer salt includes a metal salt of a carboxy group. For this reason, from the viewpoint of inhibiting the hydrolysis of the silicone surfactant, an acidic compound is typically used as a pH adjuster to neutralize the alkalinity. The content of the pH adjuster in the cleaning solution may be determined such that the pH of the cleaning solution is 7 or more and 8 or less in accordance with the content of the polycarboxylic acid polymer salt.

The acidic compound may be an inorganic acid, an organic acid, or a salt thereof. Examples of the inorganic acid include hydrochloric acid, sulfuric acid, and p-toluene sulfonic acid. Examples of the organic acid include formic acid, acetic acid, propionic acid, butyric acid, lactic acid, oxalic acid, tartaric acid, and citric acid. As the acidic compound, one type of acidic compound may be used alone, or two or more of them may be used in combination.

As the pH adjuster, particularly, a fruit acid (acid derived from fruits) is more favorable than deleterious substances such as p-toluene sulfonic acid, from the viewpoint of production safety. Further, since a fruit acid having one carboxy group (formic acid, acetic acid, etc.) has a pungent odor, the pH adjuster is more favorably a fruit acid having a low pungent odor and two or more carboxy groups from the viewpoint of production safety. Examples of the fruit acid having two or more carboxy groups include malonic acid, succinic acid, malic acid, citric acid, and tartaric acid. In this way, the cleaning solution according to this embodiment favorably further includes a fruit acid having two or more carboxy groups.

The basic compound may be an inorganic or organic basic compound. Examples of the inorganic basic compound include an alkali metal hydroxide such as sodium hydroxide and potassium hydroxide. Examples of the organic basic compound include primary to tertiary amine compounds having a small molecular amount. Among these, sodium hydroxide or potassium hydroxide, which is a strong alkali and allows the pH to be adjusted in a small amount, is favorable. As the basic compound, one type of basic compound may be used alone, or two or more of them may be used in combination.

### Viscosity Adjustor

The component and content of the viscosity adjustor are not particularly limited as long as the viscosity of the cleaning solution can be adjusted to be close to the viscosity of the ink without affecting the cleaning performance. When the viscosity of the cleaning solution is close to the viscosity of the ink, even if the cleaning solution mixes with the ink after cleaning, the viscosity of the ink does not change, enabling stable ejection.

Examples of the viscosity adjustor include a water-soluble diol typified by 1,3-propanediol and a sugar alcohol typified by glycerin. As necessary, these may each be used alone, or two or more of them may be used in combination. In particular, as the viscosity adjustor, 1,3-propanediol or glycerin is favorable.

The content of the viscosity adjustor in the cleaning solution according to this embodiment is favorably 20 mass % or more and 70 mass % or less.

### Examples and Comparative Examples

Although Examples of the present disclosure will be described below, the present disclosure is not limited to these Examples.

### (Preparation of Cleaning Solution)

First, a cleaning agent, a surface tension modifier (silicone surfactant), a viscosity adjustor, and water (ion exchanged water) were mixed to obtain the composition shown in Table 1. Then, a pH adjuster was mixed therewith as appropriate to obtain the specific pH of 7 or more and 8 or less, thereby preparing cleaning solutions according to Examples 1 to 9 and Comparative Examples 1 and 2.

TABLE 1

| | | Example | | | | | |
|---|---|---|---|---|---|---|---|
| | | 1 | 2 | 3 | 4 | 5 | 6 |
| Cleaning | Aqualic DL40 | 0.4 | — | 0.1 | 0.4 | — | 0.1 |
| solution | Aqualic TL37 | — | 0.4 | 0.3 | — | 0.4 | 0.3 |
| [mass %] | Triethanolamine | — | — | — | — | — | — |
| Surface tension | SILFACE | 0.3 | 0.3 | 0.3 | 0.3 | 0.3 | 0.3 |
| modifier | SAG503 | | | | | | |
| [mass %] | | | | | | | |
| Viscosity | 1,3- | 60 | 60 | 60 | 60 | 60 | 60 |
| adjustor | propanediol | | | | | | |
| [mass %] | | | | | | | |
| Water | Ion exchanged | Remainder | Remainder | Remainder | Remainder | Remainder | Remainder |
| [mass %] | water | | | | | | |

| | | | | | | |
|---|---|---|---|---|---|---|
| Viscosity [mPa · s] | 8 | 8 | 8 | 8 | 8 | 8 |
| Static surface tension [mN/m] | 22 | 22 | 22 | 22 | 22 | 22 |
| pH | 8 | 8 | 8 | 7 | 7 | 7 |

| | | | | | Comparative | |
|---|---|---|---|---|---|---|
| | | Example | | | Example | |
| | | 7 | 8 | 9 | 1 | 2 |
| Cleaning | Aqualic DL40 | 0.1 | 0.1 | 0.1 | 0.1 | — |
| solution | Aqualic TL37 | 0.3 | 0.3 | 0.3 | 0.3 | — |
| [mass %] | Triethanolamine | — | — | — | — | 1 |
| Surface tension | SILFACE | 1 | 0.06 | 0.02 | — | 0.3 |
| modifier | SAG503 | | | | | |
| [mass %] | | | | | | |
| Viscosity | 1,3- | 60 | 60 | 60 | 60 | 60 |
| adjustor | propanediol | | | | | |
| [mass %] | | | | | | |
| Water | Ion exchanged | Remainder | Remainder | Remainder | Remainder | Remainder |
| [mass %] | water | | | | | |

| | | | | | |
|---|---|---|---|---|---|
| Viscosity [mPa · s] | 8 | 8 | 8 | 8 | 8 |
| Static surface tension [mN/m] | 22 | 23 | 29 | 55 | 22 |
| pH | 7 | 8 | 8 | 8 | 8 |

The following cleaning agent, surface tension modifier, and viscosity adjustor were used.

### Cleaning Agent (Polycarboxylic Acid Polymer Salt)

sodium polyacrylate (“Aqualic L series DL-40” manufactured by NIPPON SHOKUBAI CO., LTD., molecular weight of 3,500)
Sodium acrylic acid/maleic acid copolymer (“Aqualic L series TL-37” manufactured by NIPPON SHOKUBAI CO., LTD., molecular weight of 5,000)

### Cleaning Agent (General Basic Compound)

Triethanolamine (manufactured by NIPPON SHOKUBAI CO., LTD.)

### Surface Tension Modifier

Silicone surfactant (“SILFACE SAG503A” manufactured by Nissin Chemical Co., Ltd.)

### Viscosity Adjustor

1,3-propanediol (manufactured by DUPONT)·

### pH Adjuster (Acidic Oxide)

p-toluene sulfonic acid aqueous solution (“PTS-70” (70% PTS aqueous solution) manufactured by Meiyusangyo Co., Ltd.)

The viscosity, the static surface tension, and the pH of each of the cleaning solutions according to Examples 1 to 9 and Comparative Examples 1 and 2 are as shown in Table 1. The static surface tension was measured using a surface tensiometer (“automatic surface tensiometer DY-300” manufactured by Kyowa Interface Science Co., Ltd.) at 25° C. conforming to the Wilhelmy method (plate method). The viscosity was measured using Lovis 2000M manufactured by Anton Paar and adjusted to 8 mPa·s at 25° C.

### (Test for Removability of Solidified Ink)

The test for removability of the solidified ink was conducted using each of the cleaning solutions according to Examples 1 to 9 and Comparative Examples 1 and 2 by the following method.

First, a solidified ink was formed on a nozzle surface of an inkjet head. Specifically, a plurality of ink droplets each corresponding to one dot was ejected onto the lower surface (nozzle surface) of the nozzle plate of an inkjet head (KJ4B-1200 manufactured by KYOCERA Corporation) from the ink supply head of another device, thereby intentionally adhering a plurality of ink dots to the lower surface. After that, the nozzle plate was dried for 72 hours in an environment of a temperature of 35° C. and a humidity of 15% to prepare a nozzle plate having a plurality of fixed ink dots (hereinafter, referred to also as “fixed ink dots”).

Next, the nozzle plate was cleaned using each of the cleaning solutions according to Examples 1 to 9 and Comparative Examples 1 and 2 by a blade wipe method, and the removability of the solidified ink was evaluated. In this case, an inkjet recording apparatus that includes a cleaning solution supply mechanism and a cleaning mechanism with a blade wipe method was used. The blade was driven at the line pressure of 10 N/m and the wiping speed of 30 mm/s to perform wiping twice. The first wiping was performed to cause the cleaning solution to wet and spread on the nozzle plate, and the second wiping was performed to remove the fixed ink dots (solidified ink) peeled off from the nozzle plate with the cleaning solution. Note that the cleaning solution was supplied at both the first wiping and the second wiping.

### (Evaluation for Removability)

The number of fixed ink dots on the nozzle surface before cleaning and after cleaning (after the second wiping) was counted, and the ratio of the number of fixed ink dots after cleaning to the number of fixed ink dots before cleaning was calculated as the removal ratio (%) of the solidified ink. In order to check the variation in results, a plurality of nozzle plates was prepared and similar tests were conducted.

The removal ratio [%] of the solidified ink was evaluated on the basis of the following criteria.
90 to 100: Very good
80 to 100: Good
60 to 80: Slightly good
20 to 30: Slightly poor
0: Poor

Further, the state of the nozzle plate after cleaning was visually observed. The removal state of the solidified ink by visual observation was evaluated on the basis of the following criteria.
A: The solidified ink could be uniformly removed, very good.
B: The solidified ink could be removed although somewhat unevenly, good.
C: The solidified ink could be removed although unevenly, slightly good.
D: The solidified ink could not be removed, poor.

Even if the evaluation the removal ratio [%] was “slightly poor” and the evaluation of the removal state was “C”, the fixed ink dots can be removed by wiping performed at a plurality of times, and this was deemed acceptable for practical use. The results of each evaluation are shown in Table 2.

TABLE 2

| | | Removal state |
|---|---|---|
| | Removal | by visual |
| | ratio [%] | observation |
| Example 1 | 80~100 | A |
| Example 2 | 90~100 | A |
| Example 3 | 90~100 | A |
| Example 4 | 80~100 | A |
| Example 5 | 90~100 | A |
| Example 6 | 90~100 | A |
| Example 7 | 90~100 | A |
| Example 8 | 60~80 | B |
| Example 9 | 20~30 | C |
| Comparative | 0 | D |
| Example 1 | | |
| Comparative | 0 | D |
| Example 2 | | |

### Results of Evaluation for Removability in Examples 1 to 9

As a result, in Examples 1 to 9 in which a silicone surfactant and a polycarboxylic acid polymer salt are included and the pH is 7 or more and 8 or less, removability within a practically acceptable range was confirmed. Among these, in Examples 1 to 8 in which the content of the silicone surfactant is 0.06 mass % or more, since the static surface tension was low, i.e., 23 mN/m or less, the removal ratio of the solidified ink was “slightly good” or better, the removal state of the solidified ink by visual observation was “good” or better, and a higher cleaning effect was observed. In particular, in Examples 1 to 7 in which the content of the silicone surfactant is 0.09 mass % or more, the surface tension remained constant at around 22 mN/m, the removal ratio of the solidified ink was “good” or better, the removal state of the solidified ink by visual observation was “very good”, and an even higher cleaning effect was observed. Further, when comparing Example 1 and Example 4, Example 2 and Example 5, and Example 3 and Example 6, which have the same composition but different pH values, of Examples 1 to 6, no significant difference in the removal state was observed between pH 7 and 8, confirming that the pH only needs to be adjusted to 7 or more and 8 or less.

### Results of Evaluation for Removability in Comparative Example 1

In the cleaning solution according to Comparative Example 1 in which no silicone surfactant is included although a polycarboxylic acid polymer salt is included, the static surface tension was high, i.e., 55 mN/m, sufficient wettability could not be achieved, and the solidified ink could not be removed.

### Results of Evaluation for Removability in Comparative Example 2

In the cleaning solution according to Comparative Example 2 in which no polycarboxylic acid polymer salt is included although a silicone surfactant is included, the static surface tension was low, i.e., 22 mN/m, but did not exhibit high cleaning performance only with the polycarboxylic acid polymer salt under neutral conditions.

### (Evaluation for Preservation Stability)

Cleaning solutions with different pH values were prepared and their preservation stability (hydrolysis resistance) was evaluated.

First, by adjusting the amount of the pH adjuster (70% PTS aqueous solution) added to the cleaning solution according to Example 6, cleaning solutions with a pH of 7.0 to 8.6 were obtained.

Next, a hydrolysis rate v was measured in an environment of a temperature of 40° C. for each of the obtained cleaning solutions with different pH values. A reaction rate constant k of hydrolysis was calculated on the basis of the measured hydrolysis rate v. The (estimated) residual amount [%] of the silicone surfactant for preservation months (at a preservation temperature of 40° C.) when the concentration of the silicone surfactant was 1% was obtained on the basis of the calculated reaction rate constant k.

FIG. 2 is a graph showing the change in the (estimated) residual amount of the silicone surfactant in cleaning solutions with different pH values as a function of preservation months (at a preservation temperature of 40° C.). The preservation stability (hydrolysis resistance) was evaluated on the basis of the following criteria.

Good: the (estimated) residual amount of a silicone surfactant at the end of preservation for 12 months, which is the minimum required preservation period, is 0.3% or more.

### (Results of Evaluation for Preservation Stability)

The results of measuring the hydrolysis rate v showed that substantially no hydrolysis occurred at pH 7 and the hydrolysis rate v of the silicone surfactant increased as the pH was further away from 7. Further, as shown in FIG. 2, the residual amount of the silicone surfactant after the preservation for 12 months was 0.0 mass % in the cleaning solution with the pH exceeding 8.0. On the other hand, in the cleaning solution with the pH of 7 or more and 8 or less, the residual amount was 0.3% or more, confirming that the hydrolysis of the silicone surfactant was inhibited and sufficient preservation stability was achieved. As described above, the cleaning solution according to the present disclosure has been confirmed to achieve a high cleaning effect for a long period of time due to its hydrolysis resistance.

It should be understood by those skilled in the art that various modifications, combinations, sub-combinations and alterations may occur depending on design requirements and other factors insofar as they are within the scope of the appended claims or the equivalents thereof.

What is claimed is:

1. An inkjet head cleaning solution that is used for cleaning an inkjet head with
a blade, comprising:
a silicone surfactant; and
a polycarboxylic acid polymer salt,
wherein the inkjet head cleaning solution has a pH of 7 or more and 8 or less.

2. The inkjet head cleaning solution according to claim 1, further comprising
a fruit acid having two or more carboxy groups.

3. The inkjet head cleaning solution according to claim 1, wherein
a content of the silicone surfactant is 0.09 mass % or more and 1 mass % or less.
